(19) United States
(12) Patent Application Publication
(10) Pub. No.: US 2008/0189153 A1
(43) Pub. Date: Aug. 7, 2008

(54) Advertisement exchange system and method

(76) Inventor: Randolph M. Haldeman, Menlo Park, CA (US)

Correspondence Address: INNOVATION STRATEGIES, INC., P.O. BOX 48577, SPOKANE, WA, 99228, US

(21) Appl. No.: 12/001,068

(22) Filed: Dec. 7, 2007

Related U.S. Application Data
(63) Continuation-in-part of application No. 11/635,375, filed on Dec. 6, 2006.
(60) Provisional application No. 60/873,655, filed on Dec. 8, 2006.

(51) Int. Cl. G06Q 30/00

(52) U.S. Cl. 705/7; 705/14

(57) ABSTRACT

A process identifies a particular advertisement that is received from an advertisement sponsor. Multiple advertisement-related services available to the advertisement are identified and information regarding those services is communicated to the advertisement sponsor. Identification of at least one selected service is received from the advertisement sponsor. The process then identifies at least one parameter associated with the advertisement. Finally, the advertisement, identification of the selected service(s), and the associated parameter(s) are then stored by the process.

### RELATED APPLICATIONS

This application is a Continuation in Part of U.S. patent application Ser. No. 11/635,375, filed Dec. 6, 2006, the disclosure of which is incorporated by reference herein. This application also claims the benefit of U.S. Provisional Application No. 60/873,655, filed Dec. 8, 2006, the disclosure of which is incorporated by reference herein.

### TECHNICAL FIELD

The present invention relates to providing various types of advertisements to one or more users, such as callers using a voice-based communication device.

### BACKGROUND

Individuals place a large number of telephone calls every day. These calls include Directory Assistance (DA) calls, Voice-over-Internet-Protocol (VoIP) calls, and enterprise content calls, such as requests for movies, information, and directions. For instance, in 2005 over 6 billion directory assistance calls were placed, billions of VoIP calls were placed, and tens of millions of enterprise content calls were placed. In many situations, consumers pay for these calls directly, such as with the service fee many directory assistance providers charge. Another way to finance certain calls is to have them sponsored by one or more advertisers.

When an advertiser wants to play an advertisement through a Directory Assistance service, enterprise content service, or other service, the advertiser selects a particular service and places the advertisement with the selected service. If an advertiser wants to play the same advertisement through multiple services, the advertiser repeats the process of placing the advertisement multiple times (once for each of the multiple services). Such repetition is tedious and time consuming for the advertiser. Thus, it would be desirable to provide a system that simplifies the process of placing an advertisement with multiple services.

### BRIEF DESCRIPTION OF THE DRAWINGS

Similar reference numbers are used throughout the figures to reference like components and/or features.

FIG. 1 illustrates an example environment in which the systems and methods discussed herein can be applied.

FIG. 2 illustrates multiple advertisement-related services, systems, devices, and entities that may interact with an advertisement management system.

FIG. 3 is a block diagram illustrating various components of an example advertisement management system.

FIG. 4 is a flow diagram illustrating an embodiment of a procedure for creating and editing advertisements on an advertisement management system.

FIG. 5 is a flow diagram illustrating an embodiment of a procedure for selecting advertisement parameters and advertisement-related services.

FIGS. 6-9 represent a flow diagram that illustrates an embodiment of a procedure for playing one or more advertisements to a caller.

FIG. 10 is a block diagram illustrating an example computing device.

### DETAILED DESCRIPTION

The systems and methods described herein allow advertisers to place a particular advertisement with multiple different services without having to repeat the advertisement placement process multiple times. The advertiser determines which services will receive each advertisement. For example, an advertiser can place a single audio-based advertisement with an advertisement management system and specify any number of different services that will play the advertisement to customers or clients of each service. These services include, for example, directory assistance services, advertisement distribution services, enterprise content services, and other advertisement-related services and organizations. The described systems and methods allow an advertiser to set a single budget for an advertisement that is shared across all of the selected services.

Additionally, the systems and methods described herein allow advertisers to create and manage multiple advertisements targeted by various parameters. These parameters include, for example, geographic area, business category, time-of-day, day-of-week, advertising budget, throttle settings, coupons, and the like. An example advertisement references an audio file and/or a text-to-speech transcript for generating an audio advertisement played to one or more telephone callers. These systems and methods allow advertisers to create advertisements that target consumers at the instant they are making a buying decision (e.g., when they call a directory assistance service requesting a particular business or product/service).

In particular embodiments, a “user” is also referred to as a “caller”. The systems and methods described herein receive calls (or requests for calls) from various callers. For example, callers may place calls to request directory assistance (also referred to as a “411 service”), call a business, call a friend, and so forth. The caller may invoke a call via a conventional telephone system, using voice over internet protocol (VoIP), or any other communication system. Directory assistance typically provides a phone number for a particular individual or business. Directory assistance systems may also connect the caller to the desired individual number. Alternatively, directory assistance may provide any type of information to a caller, such as address information, business location, business hours, etc.

Particular examples discussed herein refer to receiving directory assistance requests from callers via a telephone or a cellular phone. However, the systems and methods described herein may also be utilized to process requests received from any source using any type of data communication mechanism and any kind of data response mechanism. Although certain examples refer to calls for directory assistance, similar procedures and systems can be used to provide in-line advertisements for any type of call, including VoIP calls, calls to businesses, calls to individuals, and the like. For example, a caller initiating a VoIP call may hear an advertisement “This call is being sponsored by Acme Computer Systems” before the call is connected to the destination. Revenue from this type of advertisement helps reduce or eliminate the cost of providing the VoIP call service.

Specific examples discussed herein relate to voice advertising (e.g., playing voice or other audio-based messages to callers). However, the systems and methods discussed herein can be used with any type of advertising and with any type of advertisement management system. Alternate types of messages include text messages, email messages, instant messages, and the like. The described systems and methods may be implemented as a stand-alone system or may be incorporated into one or more other systems.

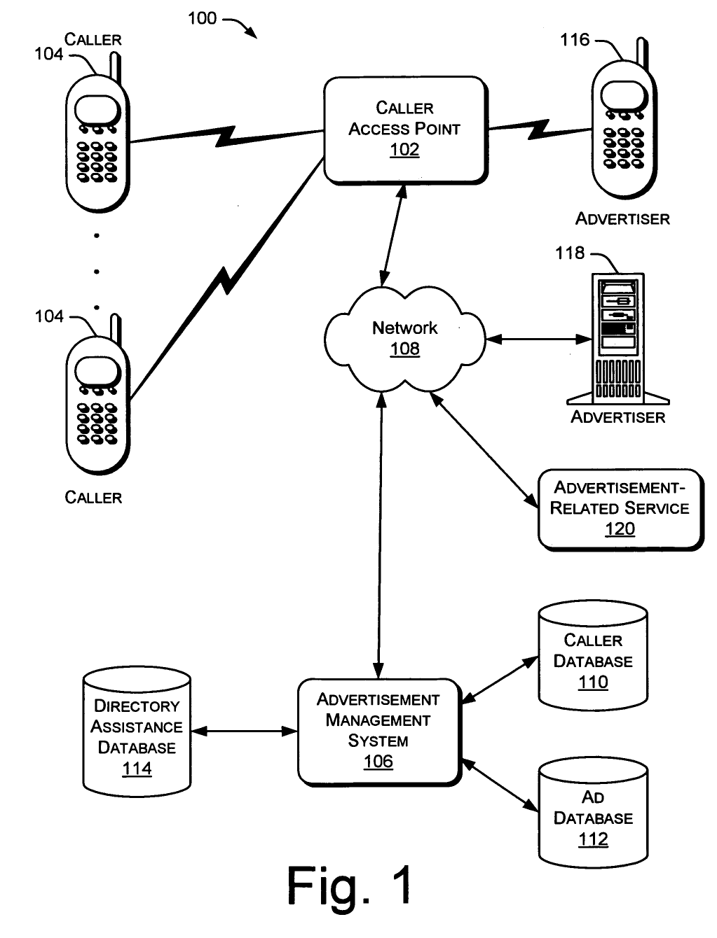

FIG. 1 illustrates an example environment 100 in which the systems and methods discussed herein can be applied. Environment 100 includes a caller access point 102, which receives calls from multiple callers 104. A typical caller access point 102 is capable of handling numerous calls from callers 104 simultaneously. Caller access point 102 may be a PBX phone system or other system capable of handling multiple calls simultaneously. In a particular embodiment, caller access point 102 is a directory assistance access point that receives requests from callers for directory assistance.

Caller access point 102 communicates with an advertisement management system 106 via a data communication network 108. Advertisement management system 106 performs various advertisement-related functions, such as creating and editing advertisements, selection and ranking of advertisements based on various factors, and playing advertisements to callers. Additional details regarding the operation of advertisement management system 106 are provided below.

Data communication network 108 can be implemented using any communication protocol and any type of communication medium. In one embodiment, data communication network 108 is the Internet. In other embodiments, data communication network 108 is a combination of two or more networks coupled to one another. Caller access point 102 and advertisement management system 106 communicate with network 108 via a wired and/or wireless communication link. In a particular embodiment, caller access point 102 and advertisement management system 106 communicate audio data using VoIP. This embodiment may utilize a VoIP bridge or gateway between caller access point 102 and network 108, and between advertisement management system 106 and network 108.

Advertisement management system 106 is also coupled to a caller database 110, an advertisement database 112, and a directory assistance database 114. Caller database 110 contains information related to various callers, such as types of businesses requested in previous calls, types of advertisements received during previous calls, geographic location of the caller, caller demographics, and the like. This caller information allows advertisement management system 106 to target appropriate ads to each caller. Advertisement database 112 contains various advertisements and information associated with those advertisements. Advertisement database 112 also contains advertisement campaign history data used for reporting, generating new advertising campaigns, and so forth. Directory assistance database 114 contains phone numbers, addresses, and other information associated with numerous businesses and individuals. Although three separate databases 110, 112, and 114 are shown in FIG. 1, alternate embodiments may include any number of databases coupled to advertisement management system 106. Further, alternate embodiments may combine database information into more or less than three databases. For example, caller database 110 and advertisement database 112 may be merged into a single database. Similarly, the data contained in caller database 110 may be distributed across multiple databases (e.g., one database for caller data mined by advertisement management system 106, and a second database for caller data obtained from a third party data source).

Caller access point 102 is also accessible by an advertiser 116 using a telephone or similar communication device. For example, advertiser 116 may communicate with advertisement management system 106 via caller access point 102 to create or edit an advertisement. Alternatively, an advertiser 118 may use a computing device to communicate with advertisement management system 106 via a connection through network 108. For example, advertiser 118 may communicate with advertisement management system 106 to create or edit an advertisement, review historical campaign data, or generate a report of advertising activity. An advertiser is also referred to as an “advertisement sponsor”.

Additionally, any number of advertisement-related service providers 120 are coupled to advertisement management system 106. Example advertisement services include directory assistance services, advertisement delivery services, and the like. These advertisement-related service providers may be coupled directly to advertisement management system 106 or coupled via network 108.

In a particular embodiment, caller access point 102 includes an invoking application, which interacts with callers and invokes advertising management system 106. The invoking application can be a directory assistance application, a VoIP application, and the like. In one implementation, the invoking application receives a call and requests one or more advertisements from advertising management system 106. Advertising management system 106 then identifies advertisements based on information associated with the received call and provides those advertisements to the invoking application for playback to the caller. The invoking application then reports information about the advertisements back to advertising management system 106. The reported information includes, for example, which ads were played to the caller, which ad was selected by the caller, and whether the caller accepted any offers, such as competitor coupons or competitor discounts. This reported information is used by advertising management system 106 to provide advertising statistics and results to the advertisers placing the various advertisements. In one embodiment, an application program interface (API), discussed below, is provided by advertising management system 106 that allows one or more invoking applications to interact with the advertising management system.

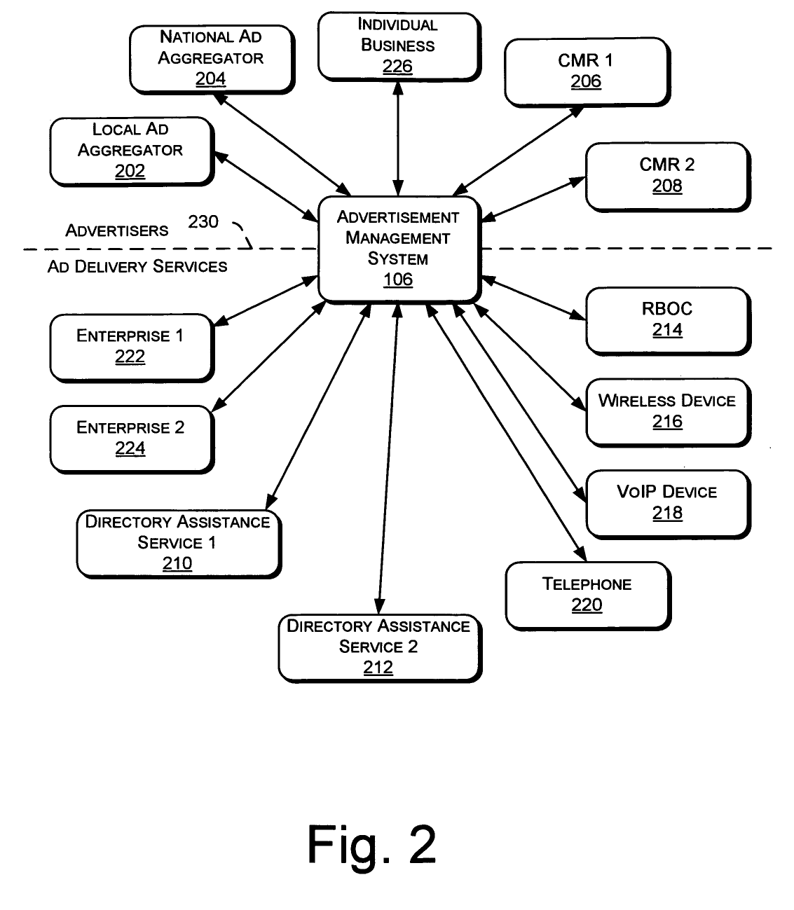

FIG. 2 illustrates multiple advertisement-related services, systems, devices, and entities that may interact with advertisement management system 106. Any number of different advertisement-related services, systems, devices, and entities can be coupled to advertisement management system 106. The general arrangement of FIG. 2 positions advertisers on the top portion of the drawing (above broken line 230) and positions advertisement delivery services on the bottom portion of the drawing (below broken line 230). In general, advertisers are businesses (or groups of businesses) that want to advertise their products and/or services. Advertisement delivery services represent various services, systems, and devices that deliver one or more advertisements to customers or other advertisement targets. Thus, advertisement management system 106 receives advertisements from multiple advertisers and controls the delivery of those advertisements to multiple advertisement delivery services.

Advertisement management system 106 performs various functions, such as aggregating advertisement budgets across multiple delivery services. Additionally, advertisement management system 106 aggregates throttle settings and other parameters across the multiple delivery services. As discussed herein, advertisers can select which multiple delivery services should be used to distribute their advertisements. Additionally, advertisers can set various ad parameters that may vary from one delivery service to another. In particular embodiments, advertisement management system 106 inserts one or more advertisements into the audio stream being provided to the caller.

In the example of FIG. 2, a local advertisement aggregator 202 and a national advertisement aggregator 204 are coupled to advertisement management system 106 along with two CMRs 206 and 208. Two directory assistance services 210 and 212 are also coupled to advertisement management system 106. FIG. 2 shows four examples of devices that allow callers to communicate (directly or indirectly) with advertisement management system 106: a regional bell operating company (RBOC) 214, a wireless device 216, a VoIP device 218, and a conventional telephone 220. Callers can communicate with advertisement management system 106 via a domestic call or an international call using any device capable of communicating directly or indirectly with the advertisement management system.

FIG. 2 also illustrates two enterprise content services 222 and 224 that are capable of communicating with advertisement management system 106. Additionally, one or more individual businesses (or small groups of businesses) 226 can communicate with advertisement management system 106.

Example enterprise content services 222 and 224 include supermarkets, department stores, mass merchandisers, movie theaters, and the like. An enterprise may be a single store (such as an independent supermarket) or a chain of stores (such as a chain of movie theaters). For example, if a customer calls a supermarket, they may be prompted to “Press 1 for the bakery or Press 2 for the Deli”. If the customer presses 1, they hear an advertisement for milk before being connected to a bakery employee. Similarly, if the customer presses 2, they hear an advertisement for potato chips before being connected to a deli employee. In another example, if a caller requests the electronics department at a mass merchandiser, they may hear an advertisement for a particular brand and model of television before being connected to an employee in the electronics department.

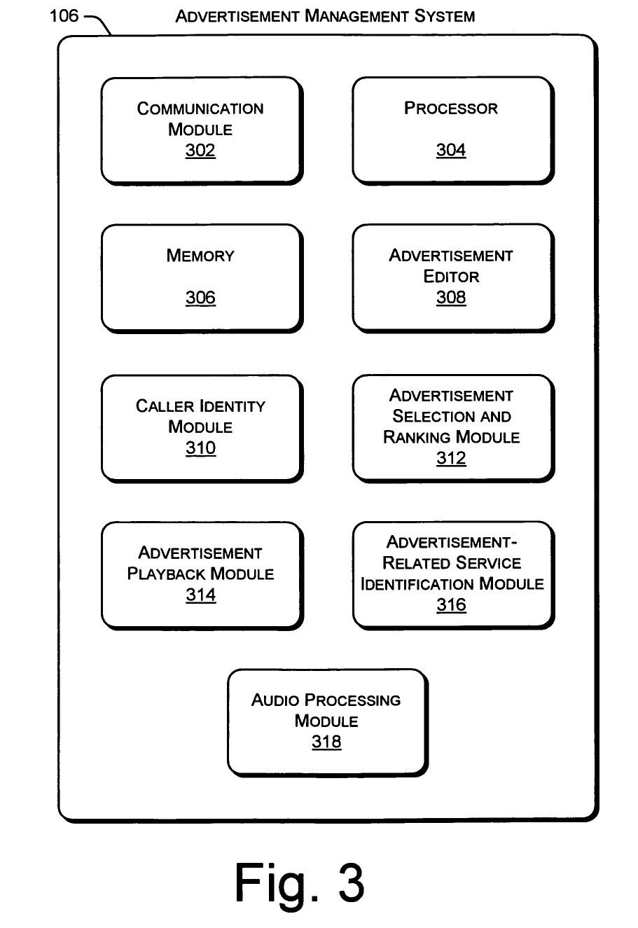

FIG. 3 is a block diagram illustrating various components of example advertisement management system 106. Advertisement management system 106 includes a communication module 302, a processor 304, and a memory 306. Communication module 302 allows advertisement management system 106 to communicate with other devices and services, such as databases, networks, other computer systems, advertisement-related services, and so on. Processor 304 executes various instructions to implement the functionality provided by advertisement management system 106. Memory 306 stores these instructions as well as other data used by processor 304 and other modules contained in advertisement management system 106.

Advertisement management system 106 also includes an advertisement editor 308, which allows users (e.g., advertisers, CMRs, and ad agencies) to create and edit advertisements. Advertisement editor 308 also allows users to define various parameters associated with each advertisement, such as the business category, time of day to run the advertisement, maximum bid price, and the like. Users can access advertisement editor 308 via a telephone or via a network connection (e.g., through the Internet). Additional information regarding creating and editing advertisements is discussed below.

Advertisement management system 106 further includes a caller identity module 310, which determines the identity of a caller. For example, caller identity module 310 may receive a phone number associated with an incoming call. Caller identity module 310 accesses a caller database or other data source to determine the identity of the caller. Once the caller is identified, additional information about the caller can be retrieved from caller database 110 or another internal or external data source. This additional information includes, for example, information requested from previous directory assistance calls, previous advertisements played to the caller, demographics of the caller, environmental factors, and the like. Example environmental factors include the current temperature in a geographic area and whether snow is forecast for the area. Such additional information is useful in targeting advertisements of interest to the caller.

Advertisement management system 106 also includes an advertisement selection and ranking module 312. This module selects one or more advertisements to be played to a caller based on various factors, which are discussed in greater detail herein. Advertisement selection and ranking module 312 also ranks multiple advertisements based on one or more criteria. This ranking determines the order in which the multiple advertisements are presented (e.g., played) to the caller. An advertisement playback module 314 plays advertisements in the form of audio files, text-to-speech data, or other data to one or more callers. Advertisement playback module 314 performs the necessary data processing to convert the advertisement data into audible sounds that are communicated to the caller.

An advertisement-related service identification module 316 contained in advertisement management system 106 identifies one or more advertisement-related services that are available to (and/or applicable to) a particular advertisement. As discussed herein, an advertisement sponsor can select all of the available advertisement-related services for an advertisement or select particular advertisement-related services for that advertisement. Advertisement-related service identification module 316 maintains a list of advertisement-related services available to advertisement management system 106 and updates that list periodically.

An audio processing module 318 performs various filtering and other modifications to audio recordings to improve the sound quality of the audio recordings and to maintain consistent volume levels, consistent audio quality, and the like between multiple audio recordings. For example, audio processing module 318 may reduce background noise, reduce “clicks and pops” in the recording, modulate the frequencies in the recording, and generally smooth the audio sounds. These audio processing steps are particularly useful for audio recordings created by a user calling on a poor quality telephone connection.

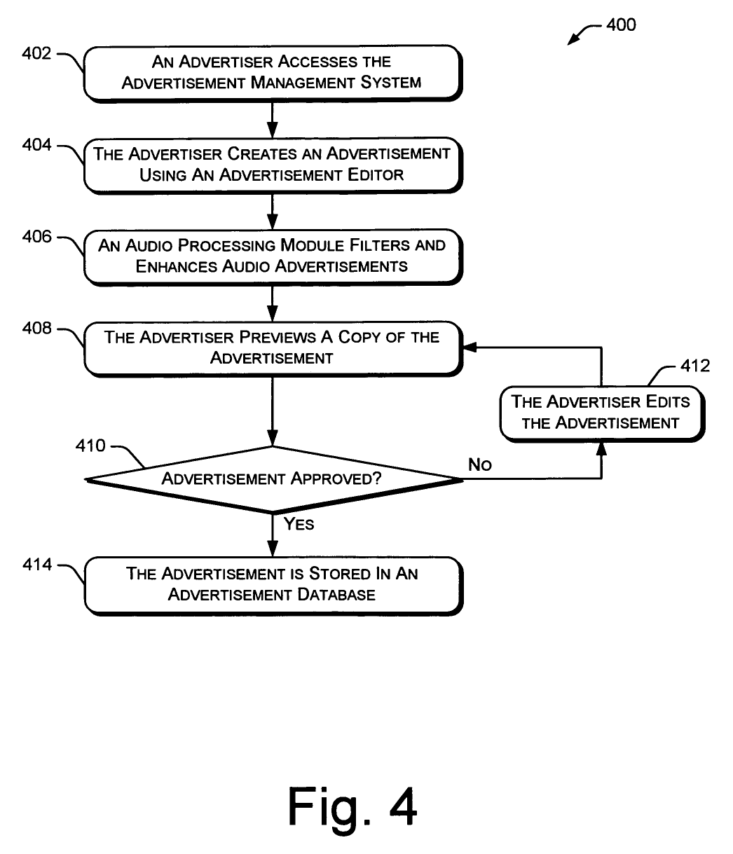

FIG. 4 is a flow diagram illustrating an embodiment of a procedure 400 for creating and editing advertisements. Initially, an advertiser accesses advertisement management system 106 discussed above (block 402). The advertiser can access the advertisement management system by telephone or via the data communication network shown in FIG. 1 using a computing device or other device capable of communicating with the advertisement management system. The advertiser continues by creating (or editing) an advertisement using an advertisement editor (block 404), such as advertisement editor 308 discussed with respect to FIG. 3.

After creating or editing an advertisement, an audio processing module filters and enhances the audio portion of the advertisement (block 406). For example, the audio processing of block 406 can perform the audio processing discussed above with respect to audio processing module 318 in FIG. 3. Next, the advertiser previews a copy of the advertisement (block 408). This preview of the advertisement includes listening to the audio portion of the advertisement and viewing any visible portions of the advertisement. If the advertiser approves the advertisement at block 410, procedure 400 continues to block 414 where the advertisement is stored in an advertisement database, such as database 112 shown in FIG. 1. If the advertiser does not approve the advertisement at block 410, the advertiser is given an opportunity to edit the advertisement (block 412) and preview the revised copy of the advertisement.

A particular advertiser may generate multiple advertisements, each of which is associated with a different type of customer or a different delivery service. For example, a manufacturer of soft drinks may advertise their cola drink via multiple advertisements. A first advertisement “This call is sponsored by Super Cola—share the experience with your family” is played to a caller initiating a personal call via a VoIP service or other communication service. The same company has a second advertisement “Buy a six pack of Super Cola using the coupon we are sending to your phone” that is played to callers that called a grocery store or other stores that sell Super Cola. The same company has a third advertisement “Buy Super Cola to go with your popcorn at the movie” that is played to callers that called a movie theater to get movie information or purchase movie tickets. Thus, the same advertiser can generate multiple advertisements for the same product that are targeted to callers in different situations.

When advertisers are setting parameters associated with their advertisements, the advertisers (also referred to as an advertisement sponsor) can identify specific delivery services to handle their advertisements and can set different parameters for each delivery service and for each advertisement. For example, when an advertiser is configuring a particular advertisement, the advertiser is presented with a list of all available delivery services—the advertiser selects the desired delivery services for the particular advertisement. Next, the advertiser sets various parameters associated with the advertisement for each of the selected delivery services. Example parameters include geographic area, time of day, day of week, throttle, and budget. Once these parameters have been selected for a first delivery service, the same parameter settings are set by default for the next selected delivery service. The advertiser is then free to modify the initial default settings. If a specific parameter doesn't apply to a particular delivery service, that parameter is not displayed to the advertiser. Additionally, if new parameters are associated with the next delivery service, those parameters are displayed to the advertiser, thereby allowing the advertiser to set those newly displayed parameters. For example, throttle settings for movies are not generally required because movie theatres don't usually restrict the number of calls they receive in a particular time period. Similarly, movie rating preferences are not relevant when configuring an advertisement for a VoIP service.

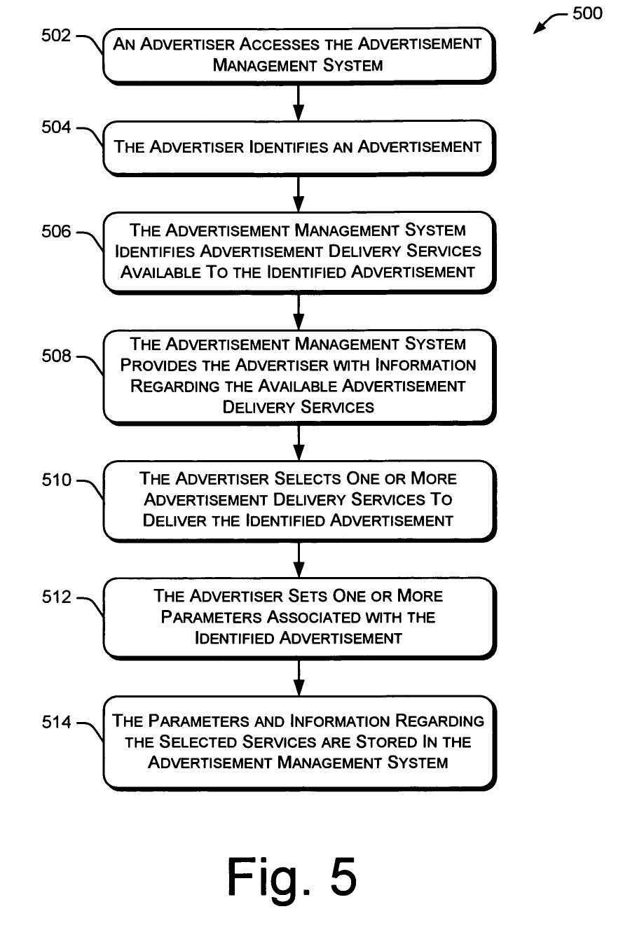

FIG. 5 is a flow diagram illustrating an embodiment of a procedure 500 for selecting advertisement parameters and advertisement-related services. Initially, an advertiser accesses the advertisement management system (block 502) and identifies a particular advertisement (block 504). Next, the advertisement management system identifies advertisement delivery services available to the identified advertisement (block 506). The advertisement management system then provides the advertiser with information regarding available advertisement delivery services (block 508).

Procedure 500 continues as the advertiser selects one or more advertisement delivery services to be associated with the identified advertisement (block 510). After selecting one or more advertisement-related services, the advertiser sets one or more parameters associated with the identified advertisement (block 512). Example parameters include type of advertisement, business category, maximum bid price, and a number of times that the advertisement can be played in a particular time period. Table 1 below identifies various parameters that can be associated with a particular advertisement. Finally, the parameters and information regarding the selected advertisement-related services associated with the identified advertisement are stored in the advertisement management system (block 514). For example, the parameters and service information may be stored in advertisement database 112 shown in FIG. 1 or any other storage device.

The following Table identifies multiple parameters that can be associated with advertisements. Certain advertisements may use a portion of the parameters shown in Table 1.

TABLE 1

| Parameter | Description | Example |
|---|---|---|
| Ad Type | Front-End Sponsor Ad, | Sponsor Ad for |
| | Back-End Sponsor Ad, | Pizza Delivery |
| | Competitive/Switch- | |
| | Away Ad, My Listing | |
| | Ad, and Category Ad | |
| Ad Category | Business category | Automobiles |
| Ad Sub-Category | Business sub-category | Porsche |
| | | Automobiles |
| Monthly Budget | Monthly limit across all | $5000/month |
| | advertisements | |
| Daily Budget | Daily limit across all | $200/day |
| | advertisements | |
| Ad Budget | Monthly limit per ad | $50 per ad/month |
| Day of Week | Days advertisement will | Friday through |
| | be played | Sunday |
| Time of Day | Times advertisement will | 9:00 am-3:00 pm |
| | be played | |
| Locality | Geographic area in | San Francisco |
| | which advertisement will | Metro Area |
| | be played | |
| Max Bid | Maximum amount the | $1.50/placement |
| | advertiser is willing to | |
| | pay for a single ad | |
| | placement or connection | |
| Throttle | Defines the maximum | Maximum of 10 |
| | frequency of ad | calls per hour |
| | placement | |
| Routing | Defines the exit handling | Route to Order |
| | for an ad placement | Capture System |
| Audio Content | The audio file or | Acme.wav |
| | transcript containing the | |
| | voice content of the | |
| | advertisement | |
| Wireless Content | The image file or text | AcmeCoupon.jpg |
| | containing the wireless | (coupon image) |
| | content of the | |
| | advertisement | |

A particular advertisement may include some or all of the parameters identified in Table 1. For example, an advertisement that does not include an image or text will not have an associated Wireless Content parameter. The Locality parameter may be nationwide or define a state, city, metropolitan area, area code, or area code and prefix.

An advertisement for a pizza restaurant might have the hours for ad placement match the hours they are open, for example 11 am to 10 pm, with no throttle defined during most of the day. However, since they have lots of business between the hours of 5 to 7 pm, they would create a separate placement for that timeframe and could set the throttle to 12. This would mean that they would get no more than 12 calls per hour during those 2 hours, and these calls would be distributed over the 60 minutes, preferably occurring approximately once every five minutes. This would give the restaurant time to handle all their other customers.

Additionally, the particular parameters associated with an advertisement are applied across all associated advertisement-related services. For example, an advertisement can have an associated throttle of 12 calls per hour and three associated directory assistance services. The advertisement management system applies the throttle parameter regardless of which service(s) provide the advertisement, thereby preventing each of the three directory assistance services from providing 12 calls per hour (a total of 36 calls). In one situation, a first directory assistance service may play the advertisement four times in a particular hour, a second service plays the advertisement eight times in that hour, and the third service does not play the advertisement during that hour.

In particular embodiments, five different types of advertisements are supported: front-end sponsor advertisements, back-end sponsor advertisements, competitive advertisements (also referred to as “switch-away advertisements”), my-listing advertisements, and category advertisements. Front-end sponsor ads are typically played to a caller as soon as the caller is connected to the service. A particular type of front-end sponsor ad, a targeted spot ad, selects among several ads to play based on information known about the caller. For example, if a particular caller has previously called directory assistance and requested pizza businesses, the advertisement management system will likely play a pizza-related sponsor ad for that caller. Additionally, the advertisement management system may charge more for a pizza-related advertisement played to this particular caller because the caller has previously requested pizza businesses before. For example, the advertiser is charged 35 cents for an advertisement played to a caller who previously requested a pizza business, and the advertiser is charged 25 cents for the same advertisement played to a caller who had not previously requested a pizza business.

A back-end sponsor ad is typically played when no “middle ad” has been played, such as a switch-away, my listing, or competitive ad. A “my listing” ad is an ad for the sponsor's business. A back-end sponsor ad is typically played if it matches and complements the front-end ad. In the example above, if a pizza-related ad was played to the caller and no middle ad was played, a back-end sponsor pizza ad from the same sponsor could be played to the caller before the call transfer is made, to remind the caller one last time of their product or service.

A competitive/switch-away advertisement is provided to a caller in response to the caller's request for a competitor's business. For example, if a caller requests the phone number for “Bob's Pizza”, a competitive ad would provide information (e.g., via an audio ad) to the caller regarding a different company (such as “Pizza Depot”), which is a competitor of “Bob's Pizza”. Competitive advertisements may be triggered in response to requests for one or more specific businesses or in response to a request for any business in a particular category. For example, an advertiser (Bob's Pizza) can create a competitive advertisement for callers requesting “Mike's Pizza”. In this example, the advertisement is only played when people request “Mike's Pizza”. Alternatively, the advertiser (still Bob's Pizza) can create a competitive advertisement for callers requesting any pizza business by name. In this situation, the advertisement is played when a caller requests “Mike's Pizza”, “Roundhouse Pizza”, or any other pizza business meeting the locale and other parameters set by the advertiser.

A category advertisement is associated with a particular business category. When a caller asks to search by category, typically two or three ads would play matching the caller's category and the caller would be given an opportunity to be connected to one of the advertisers. Pricing for category advertisements can be set by auction (as described herein) or by paying a specific price to obtain a particular rank among the multiple ads. Alternatively, the cost of a category advertisement may have a cost associated with playing the ad to the caller, an additional cost for ranking the ad in one of the top positions for earlier playback to the caller, and an additional cost if that ad is selected by the caller.

Pricing on all ads is typically set in an auction, based on maximum bid information provided by the advertiser when creating or placing the advertisement. Pricing may vary depending on the type of ad, time-of-day, day-of-week, and so forth. When an advertiser is creating or editing an ad, the advertisement management system reports the current high bids for the same category of advertisement in the same locale. Reporting current high bids lets the advertiser choosing a maximum bid for their advertisement. For example, if the top three bids are “30 cents”, “35 cents” and “50 cents”, and the advertiser bids less than 30 cents, their ad will not likely be one of the top three ads provided to callers. Based on the advertiser's bid, the advertisement management system determines the placement of that ad among other competing ads.

In a particular embodiment, if a particular ad is pushed out of the “top three” ads for a particular category and locale, the advertiser associated with the “pushed out” ad is notified via an outbound call, email, text message, or other notification system. The advertiser associated with the “pushed out” ad is given the current top three bids for the particular category and locale. The advertiser is then given an opportunity to increase the bid for their ad to put their ad back in the “top three” ads for the particular category and locale. In other embodiments, an advertiser is notified if their ad is pushed out of the top position, the top two positions, or any other number of top positions.

When setting maximum bid values for advertisements, the advertiser can also specify a daily maximum value for each advertisement, for a group of advertisements, or for all of the advertisements associated with a particular advertiser. Similarly, the advertiser can specify a weekly or monthly maximum value for each advertisement, for a group of advertisements, or for all advertisements associated with a particular advertiser.

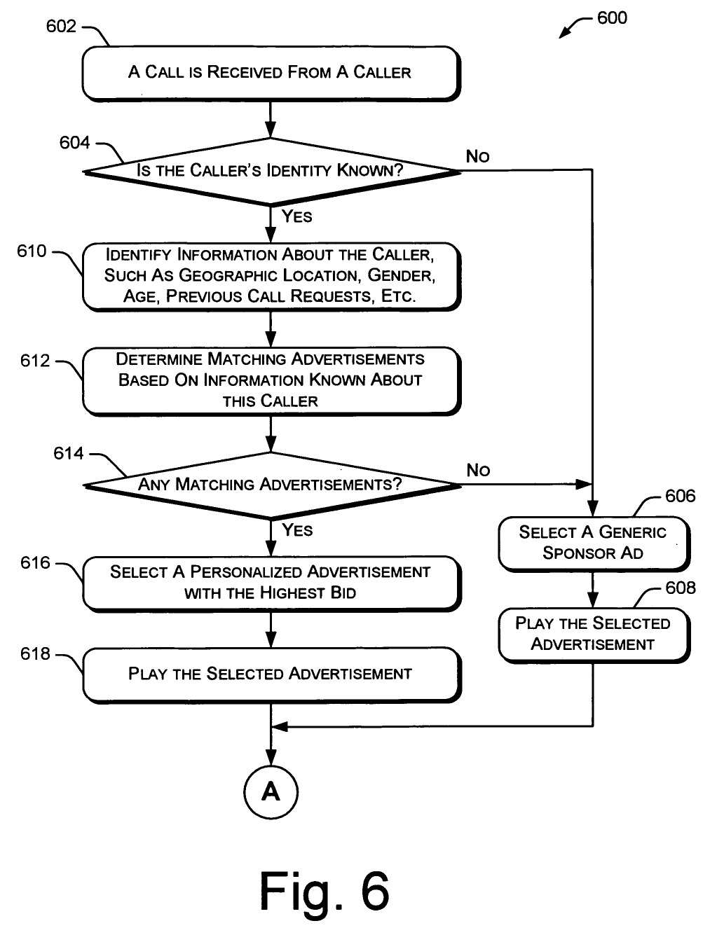

FIGS. 6-9 represent a flow diagram that illustrates an embodiment of a procedure 600 for playing one or more advertisements to a caller. Initially a call is received from a caller (block 602). Procedure 600 then determines whether the caller's identity is known, for example, by accessing a caller database and identifying the caller's identity based on the incoming call phone number (block 604). If the caller's identity is not known (e.g., no incoming call phone number or no record in the caller database), the procedure branches to block 606 where a generic sponsor advertisement is selected. Non-targeted sponsor ads are played based on bid value. If all bid values are the same, the ad that was played the longest time ago would be played next. Alternatively, if all bid values are the same, an advertisement may be selected at random. The selected advertisement is then played for the caller (block 608). This type of advertisement is an example of a front-end sponsor advertisement.

If the caller's identity is known at block 604, the procedure continues to block 610 where procedure 600 determines information about the caller, such as the geographic location of the caller, the caller's gender, the caller's age, one or more business categories associated with previous directory assistance requests, or other known data about the caller. The procedure then determines whether the advertisement management system contains any available advertisements that match the interests or preferences of the caller (block 612). If not, the procedure branches to block 606 to select a generic sponsor advertisement and then to block 608 to play the selected advertisement.

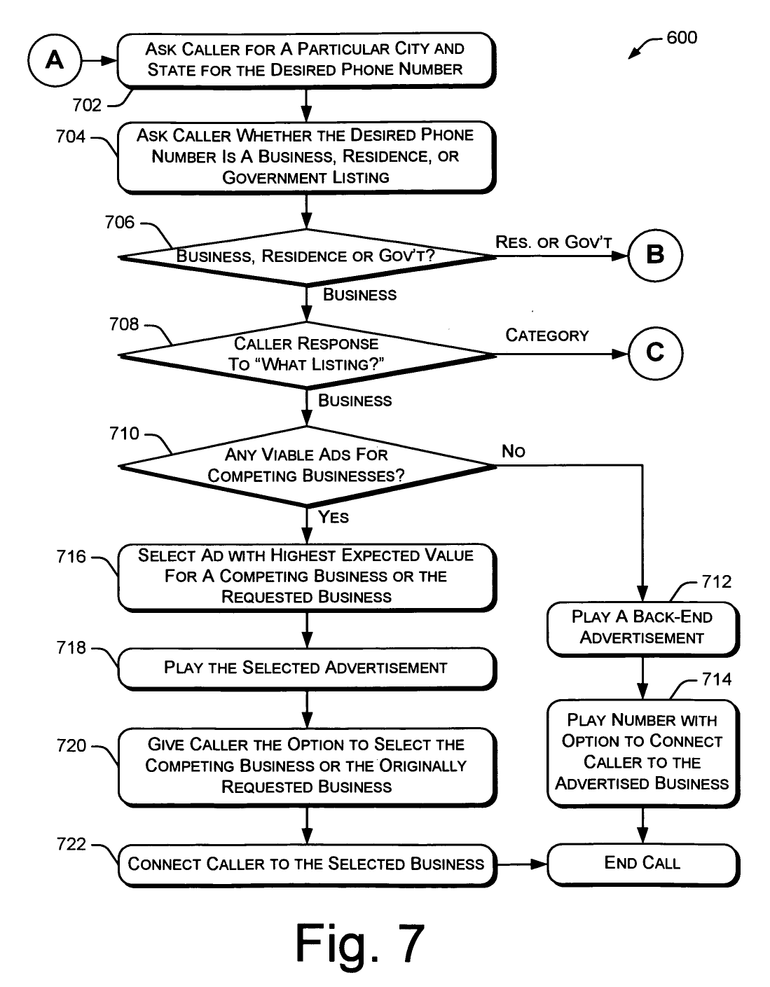

If procedure 600 determines that the advertisement management system contains one or more available advertisements that match the interests or preferences of the caller, the procedure selects a personalized advertisement with the highest bid (block 616). Next, the procedure plays the selected advertisement (block 618) and continues with the call at point “A” in FIG. 7.

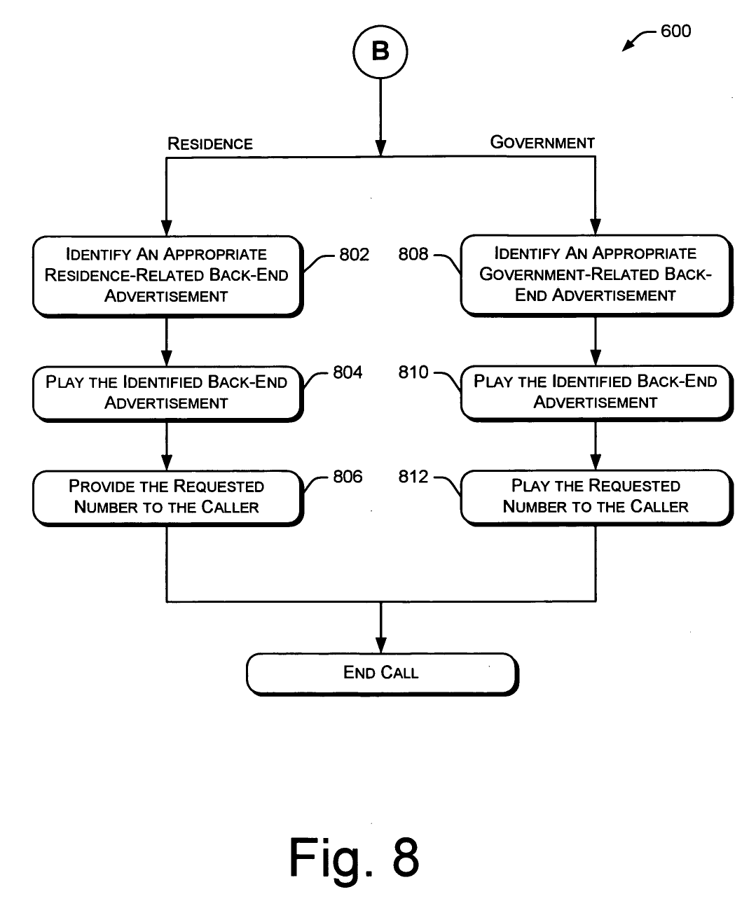

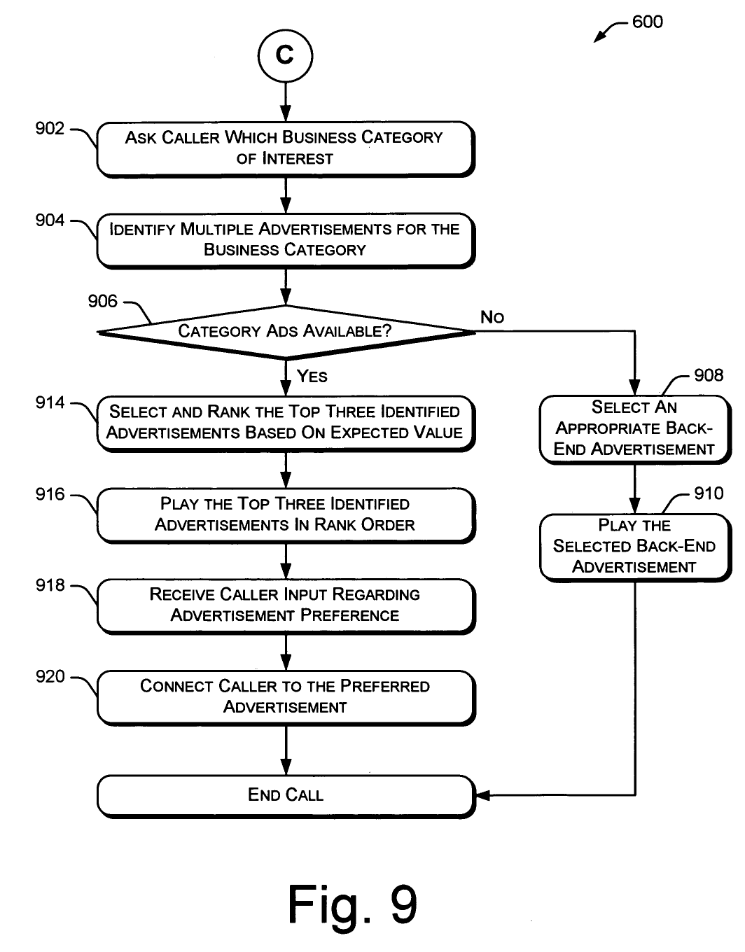

In FIG. 7, procedure 600 continues as the automated or live operator asks the caller for the city and state of their search (block 702). Next, the operator will ask if it is a search for a business, government, or residential listing (block 704). If the search is for a government or residence listing, the call branches to point “B” in FIG. 8. If the search is a request for a business, the procedure continues to block 708, where the operator asks the caller “what listing?” If the caller's response is for a particular category of business, the procedure branches to point “C” in FIG. 9. Otherwise, the caller's response is treated as a request for a business listing, and the procedure determines whether the advertisement management system contains a “my listing” ad for that particular business or any available advertisements for competing businesses (block 710). If not, the procedure branches to block 712 to select and play an appropriate back-end sponsor advertisement and then to block 714 to play the number with the option to connect the caller to the advertised business.

If procedure 600 determines that the advertisement management system contains one or more viable advertisements for a competing business, the procedure selects the advertisement with the highest expected value (block 716). An ad is deemed viable if it matches all the parameters set by the advertiser, such as time-of-day, day-of-week, location, budget, throttle, etc. When selecting an advertisement with the highest expected value (i.e., an advertisement that is expected to generate the highest revenue for the entity providing the advertising service), the process may consider bids for various types of ads. For example, the procedure may consider bids for “my listing” type advertisements as compared to “switch away” type advertisements for competing businesses. If a particular “my listing” advertisement has a bid of $1.00 and a related “switch away” advertisement has a bid of $1.50, the procedure will select the “switch away” advertisement instead of the “my listing” advertisement.

Procedure 700 then plays the selected advertisement (block 718) and gives the caller the option to select the competing business or the originally requested business (block 720). The caller is then connected to the selected business (block 722). Finally, the procedure ends the current call.

All viable competitive ads and category ads are selected based on their bid values and expected value. In one example, a caller to a business listing can be redirected 40% of the time to a competitor if a coupon is offered by the advertiser, but only 20% of the time if no coupon is offered. In a particular situation, the caller is asking for “Bob's Pizza” and there are two viable ads for that time of day and day of week. One ad, with no coupon has a bid of $4.00, while another ad with a coupon has a bid of $3.00. The system would play the $3.00 ad since its expected value is $1.20 ($3.00×40%) while the other ad had an expected value of $0.80 ($4.00×20%).

In the example above, coupons can be sent to a caller's phone, personal digital assistant (PDA), fax machine, email address, or other device/account for display or other rendering on the phone or other device. Such coupons are particularly useful with competitive advertisements. In addition to coupons, the caller may be sent maps, directions, product photos, and the like. These items may be in a text format, a visual format (such as JPEG), an HTML format, or any other format understood by the receiving device.

In FIG. 8, procedure 600 continues from point “B” by following the left path if the caller requested a residence and following the right path if the caller requested a government listing. If the caller requested a residence listing, the procedure identifies an appropriate back-end advertisement for the caller (block 802). For example, the procedure may select a back-end advertisement that is associated with a previously played front-end advertisement. The procedure then plays the identified back-end advertisement (block 804). Finally, procedure 600 provides the number associated with the requested listing to the caller (block 806). The procedure then ends the call.

If the caller requested a government listing, the procedure identifies an appropriate back-end advertisement for the caller (block 808). The procedure then plays the identified back-end advertisement (block 810). Next, procedure 600 provides the number associated with the requested listing to the caller (block 812). The procedure then ends the call.

In FIG. 9, procedure 600 continues from point “C” by asking the caller what business category they are seeking (block 902). The procedure continues by identifying multiple advertisements for the requested business category (block 904) or by identifying multiple advertisements for businesses in the same business category.

If there are no viable ads that match the category of the caller, the system will read out the names of numbers of the listings to the caller, then the ad system will select an appropriate back-end sponsor advertisement (block 908). The system then plays the selected back-end sponsor ad (block 910) and ends the call.

If there are viable ads that match the category request of the caller, one embodiment of the advertisement management system selects and ranks the top three identified advertisements, based on their expected value (block 914). In alternate embodiments, the advertisement management system selects and ranks any number of top identified advertisements (such as the top two advertisements or the top five advertisements).

Procedure 600 continues by playing the top three identified advertisements in rank order (block 916). Next, the procedure receives caller input regarding their advertisement preference (block 918) and connects the caller to the source of the preferred advertisement (block 920). The procedure then ends the call.

In alternate embodiments, a caller may provide one or more keywords instead of the name of a company. For example, a caller may request “pipe repair” rather than “plumber” or “Bob's Plumbing”. In this situation, the systems and methods described herein search for businesses that most closely match the keyword provided by the caller. The systems and methods may then identify one or more advertisements to play for the caller following the procedures discussed herein.

The advertising management system discussed herein collects information regarding advertisement statistics for reporting to advertisers. For example, the advertising management system stores information regarding the number of times an advertisement is played to a caller, the number of times an advertisement is selected by a caller, the cost of each advertisement playback, the ranking position of each advertisement playback, and so forth. This information is reported to advertisers to allow the advertisers to evaluate the results of their advertising campaigns.

As mentioned above, in certain embodiments an application program interface (API) is provided by advertising management system 106 (FIG. 1) that allows one or more invoking applications to interact with the advertising management system. Example API parameters include geographic locality, business category, number of advertisements desired, dialed number information service (DNIS) data, and automatic number information (ANI) data.

When a caller provides a directory service request, the systems and methods described herein may consider multiple business categories to find an advertisement that is likely to be of interest to the caller. For example, if the caller requests “A pizza store in Columbus”, the advertisement management system attempts to locate advertisements for one or more pizza stores in the Columbus area. If one or more viable advertisements are located, the advertisement management system plays one or more of the advertisements for the caller. If no viable advertisements are located for pizza stores in Columbus, the advertisement management system considers the parent business category (Italian Restaurants in this example). If one or more viable advertisements are located in the Italian Restaurants category, one or more of those advertisements are played for the caller. Otherwise, the advertisement management system considers the next parent business category (Restaurants in this example). If one or more viable advertisements are located in the Restaurants category, one or more of those advertisements are played for the caller. This process continues until a viable advertisement is located or a root business category is reached (e.g., there are no parent business categories associated with the current business category).

In particular embodiments, various types of advertisement-related data is reported to advertisers or other users. For example, a basic report may be generated monthly that includes information regarding which advertisements were played, the number of times each advertisement was selected by a caller, the cost of the advertisements played, and the remaining balance in the advertiser's account.

Another type of report may provide more detailed information, such as information that may help an advertiser improve the value of their advertisements. For example, this “business intelligence” report may provide useful information regarding how advertisements for similar businesses are performing compared to the advertiser for which the report is generated. Similar businesses may be in similar geographic areas, in similar business categories, run similar types of advertisements, etc. The report may also include the exact advertisement language (printed or in audio format) that is used by a similar business. The report may identify what other businesses are doing differently than the advertiser for which the report is generated (e.g., running advertisements at different times or on different days, offering coupons to callers, keywords used to trigger advertisements, and using competitive advertisements).

The report may also indicate the number of times the current advertiser's business was requested by a caller but, after hearing a competitive advertisement, the caller selected the competitive advertisement instead of the originally requested business. The report can also include bid information, such as the maximum bid of similar businesses, the average bid by similar businesses, etc. These reports may be offered to advertisers through a monthly subscription, a weekly subscription, or a one-time purchase. The information contained in these reports can be communicated to advertisers in any manner, such as via a printed report, email, audio file, etc.

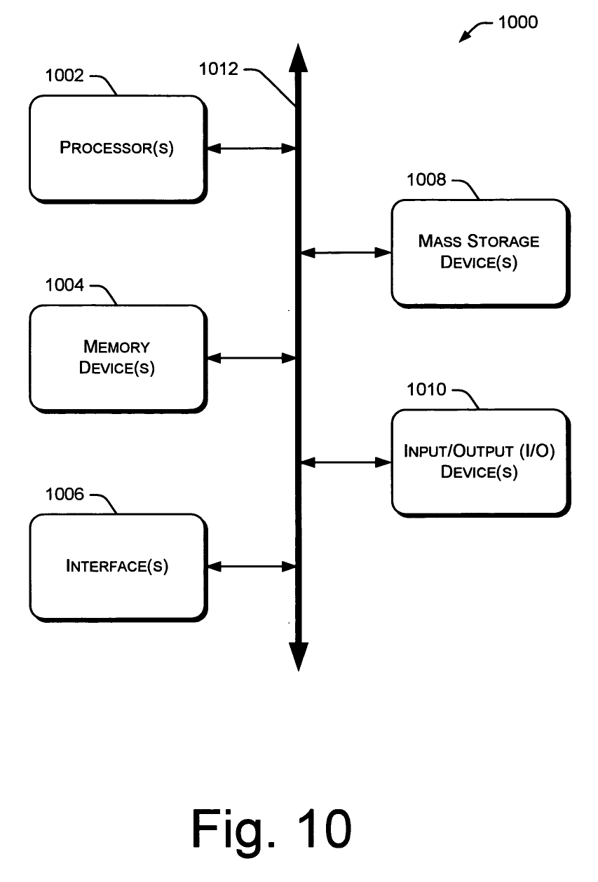

FIG. 10 is a block diagram illustrating an example computing device 1000. Computing device 1000 may be used to perform various procedures, such as those discussed herein. Computing device 1000 can function as a server, a client, or any other computing entity. Computing device 1000 can be any of a wide variety of computing devices, such as a desktop computer, a notebook computer, a server computer, a handheld computer, and the like.

Computing device 1000 includes one or more processor(s) 1002, one or more memory device(s) 1004, one or more interface(s) 1006, one or more mass storage device(s) 1008, and one or more Input/Output (I/O) device(s) 1010, all of which are coupled to a bus 1012. Processor(s) 1002 include one or more processors or controllers that execute instructions stored in memory device(s) 1004 and/or mass storage device(s) 1008. Processor(s) 1002 may also include various types of computer-readable media, such as cache memory.

Memory device(s) 1004 include various computer-readable media, such as volatile memory (e.g., random access memory (RAM)) and/or nonvolatile memory (e.g., read-only memory (ROM)). Memory device(s) 1004 may also include rewritable ROM, such as Flash memory.

Mass storage device(s) 1008 include various computer readable media, such as magnetic tapes, magnetic disks, optical disks, solid state memory (e.g., Flash memory), and so forth. Various drives may also be included in mass storage device(s) 1008 to enable reading from and/or writing to the various computer readable media. Mass storage device(s) 1008 include removable media and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, lenses, CCDs or other image capture devices, and the like.

Interface(s) 1006 include various interfaces that allow computing device 1000 to interact with other systems, devices, or computing environments. Example interface(s) 1006 include any number of different network interfaces, such as interfaces to local area networks (LANs), wide area networks (WANs), wireless networks, and the Internet.

Bus 1012 allows processor(s) 1002, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1000, and are executed by processor(s) 1002. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving identification of an advertisement by an advertisement sponsor;
identifying a plurality of advertisement-related services available to the advertisement;
communicating information regarding the available advertisement-related services to the advertisement sponsor;
receiving identification of at least one selected service from the advertisement sponsor;
identifying at least one parameter associated with the advertisement; and
storing the advertisement, identification of the at least one associated service, and the at least one associated parameter.

2. A method as recited in claim 1 wherein the plurality of advertisement-related services include a directory assistance service.

3. A method as recited in claim 1 wherein the plurality of advertisement-related services include a business enterprise representing a plurality of consumers.

4. A method as recited in claim 1 wherein the at least one parameter associated with the advertisement is a maximum bid price for the advertisement.

5. A method as recited in claim 1 wherein the at least one parameter associated with the advertisement is a geographic area associated with the advertisement.

6. A method as recited in claim 1 wherein the at least one parameter associated with the advertisement is a maximum number of times to play the advertisement using any of the selected advertisement-related services during a particular time period.

7. A method as recited in claim 1 wherein the advertisement is an audio-based advertisement.

8. A method comprising:
identifying an audio-based advertisement associated with an advertisement sponsor;
identifying a plurality of services capable of communicating the audio-based advertisement to a caller;
communicating information regarding the plurality of services to the advertisement sponsor;
receiving identification of multiple selected services from the advertisement sponsor;
identifying a parameter associated with the audio-based advertisement; and
applying the parameter associated with the advertisement across the plurality of services.

9. A method as recited in claim 8 further comprising communicating the audio-based advertisement to each of the multiple selected services.

10. A method as recited in claim 8 further comprising:
communicating the audio-based advertisement to each of the multiple selected services; and
communicating the parameter associated with the audio-based advertisement to each of the multiple selected services.

11. An advertisement management system comprising:
a service identification module to identify at least one advertisement-related service available to particular advertisements;
an advertisement selection module coupled to the service identification module, the advertisement selection module to identify a highest value advertisement that satisfies at least one parameter; and
an advertisement playback module coupled to the advertisement selection module, the advertisement playback module to communicate the identified advertisement to the at least one advertisement-related service.

12. An advertisement management system as recited in claim 11 further comprising a caller identity module coupled to the advertisement selection module, the caller identity module to identify information associated with a caller.

13. An advertisement management system as recited in claim 11 further comprising a memory device coupled to the advertisement selection module, the memory device to store parameters associated with a plurality of advertisements.

14. An advertisement management system as recited in claim 13 wherein the parameters include maximum bid prices associated with the plurality of advertisements.

15. An advertisement management system as recited in claim 11 further comprising an advertisement editor to edit advertisement content and associated advertisement parameters.

16. An advertisement management system as recited in claim 11 further comprising a communication module to communicate advertisements to a plurality of callers.
